(19) United States
(12) Patent Application Publication
(10) Pub. No.: US 2025/0087067 A1
(43) Pub. Date: Mar. 13, 2025

(54) METHOD FOR NOTIFYING A USER OF AN EVENT, FOR EXAMPLE IN THE EVENT OF A DISASTER

(71) Applicant: fm marketing gmbh, Neumarkt am Wallersee (AT)

(72) Inventors: Ferdinand Maier, Neumarkt am Wallersee (AT); Chris Langdon, Burnaby (CA)

(21) Appl. No.: 18/829,718

(22) Filed: Sep. 10, 2024

(30) Foreign Application Priority Data
Sep. 11, 2023 (DE) 10 2023 124 465.5

(51) Int. Cl. G08B 5/22

(52) U.S. Cl. CPC G08B 5/225

(57) ABSTRACT

The invention relates to a method for notifying a user of an event and comprises the steps: receiving a push message, based on the event, with configuration information describing the configuration of a call-to-action button, referred to as a CTA button, on a remote control, at least in part; generating a push command instructing a signal transmitter to prompt the user to press the CTA button on the remote control; and generating a configuration instruction that instructs the remote control to configure the remote control in the area of the CTA button based on the configuration information; sending the push command to the signal transmitter; sending the configuration instruction to the remote control; and receiving an operating feedback displaying the operation of the CTA button by the user.

### TECHNICAL FIELD

The present invention relates to method for notifying a user of an event, a control device for carrying out the method and a system comprising the control device.

### BACKGROUND

US2015/0100167A1 discloses a smart home system with a remote control on which special buttons called lens buttons are arranged with a transparent surface. In addition to entering commands, they can also serve as visual indicators. A light ring installed behind the buttons can indicate the status of smart devices. The smart home system also includes a hazard detector with seven different sensors, including smoke, heat and carbon monoxide sensors for triggering alarm signals and issuing voice messages with calls to action to inform a user what type of hazard (e.g. smoke or carbon monoxide) has been detected and where this hazard is located (e.g. in the living room or bedroom). The calls to action contain specific instructions for further action, such as “Leave the room now” or “Get some fresh air”.

US2004/0107444A1 discloses highlighting a button on both a remote control and a television to guide a user via both the remote control and the television and to ensure that the correct button is pressed. Both displays—on the remote control and on the television—work together to guide the user.

US2016/0044383A1 discloses the display of a call-to-action button on the television that prompts the user to participate in an e-commerce event. The interaction takes place via the remote control, with the user confirming an action that can then involve another device (e.g. a tablet).

US2017/0153790A1 discloses an incident management system that enables a user to respond to an alarm message via a mobile device. The alarm message is sent through the network to the mobile device where it is displayed on a map, along with icons for relevant emergency services in the vicinity of the alarm. The system enables direct communication with these emergency services via the mobile device. A confirmation of the alarm by the user can also be captured and sent back to the server to ensure that the incident has been recognized.

US2018/0098109A1 discloses a system in which a remote control with a touch screen is used to control an image display device. The remote control displays device settings and functions, enables micro-control and reduces physical buttons. The interactions between the remote control and the display device take place locally, without central monitoring of the user activity.

US2004/0113892A1 discloses a remote control that allows the user to customize button labels on a touchscreen display. When a button is pressed, a display shows the user-defined name or label of the button, which is particularly useful for universal remote controls to display the actual function of a button. Two main modes are described: a learning mode, in which users can create a label after learning a new function, and a setup mode, in which button labels can be customized at any time.

### SUMMARY

The task of the invention is to improve the object in the following technical respect.

The task is solved by the features of the independent claims. Preferred embodiments are the subject of the dependent claims.

According to one aspect of the invention, a method for notifying a user of an event comprises the steps:
receiving a push message that is based on the event including configuration information describing the configuration of a call-to-action button, referred to as a CTA button, on a remote control, at least in part;
generating a push command instructing a signal transmitter to prompt the user to press the CTA button on the remote control; and
generating a configuration instruction that instructs the remote control to configure the remote control in the area of the CTA button based on the configuration information;
sending the push command to the signal transmitter;
sending the configuration instruction to the remote control; and
receiving an operation feedback indicating the operation of the CTA button by the user, and/or
sending a message (58) indicating the operation of the CTA button (26) by the user to a control system (36).

An event-based push notification informing about an event is defined below as an automated notification sent in real time to a terminal device, such as a set-top box, to inform about a specific triggering event. This notification is triggered by predefined criteria or trigger mechanisms that respond to changing conditions, important incidents or other relevant events. The purpose of the notification can vary depending on the context and ranges from urgent warnings in emergency situations to promotional messages. In contrast, a controlling push command is a form of message transmission that, unlike an informative push message, triggers a specific action on the signal transmitter.

A call-to-action button, hereinafter referred to as CTA button, is a button on a remote control or an interactive button in a user interface that is used to prompt or direct the user to perform a specific action. These buttons are usually designed to be eye-catching and may contain short, concise texts that prompts the user to interact, such as “Get help now”, “Raise alarm” or “Send emergency call” etc. The CTA button comes as a configuration element from the design of websites, apps and other user interfaces and plays a decisive role in user guidance and conversion optimization. A click on the CTA button usually achieves a specific goal, for example by alerting the nearest emergency services, automatically making a predefined emergency call or initiating special safety protocols. The CTA button should not be understood as limiting in the context of the invention described below.

The specified method is based on the consideration that although the smart home system mentioned at the beginning is able to process messages such as those that occur in the emergency management scenario used there and to output them to a user of the smart home system, however, it is not possible to determine with the smart home system mentioned at the beginning whether these messages have actually been noticed.

This is where the specified procedure comes into play with the idea of sending a request to the user to press the CTA button on their remote control, which is displayed to them, in addition to the actual notification of the event. In this way, the receipt of a feedback message can be used to clarify whether the user has actually noticed the event. In the case of an emergency message as an event, for example, users who, for whatever reason, are not aware of the corresponding emergency can be recognized in this way so that special attention can be paid to them in the event of an emergency when emergency measures are initiated. It does not matter whether the user feedback is collected on a central server or processed locally, for example to warn the neighborhood by switching on local warning signaling devices based on the feedback. In any case, in an emergency, the confirmation with the CTA button that the push message has been noticed can help rescue services or other emergency responders to be deployed more efficiently, as they know which households are already informed and which are not, whether collected centrally or by display via local warning signaling devices.

In a further embodiment of the specified method, the push command comprises the configuration information, wherein a screen as a signal transmitter is instructed to display an image of the CTA button. In this way, the user can be given an intuitive instruction for pressing the CTA button, which he can easily understand and implement immediately.

In an additional further embodiment of the method described, the image of the CTA button is superimposed over another image on the screen. In this way, the user's attention on the screen can be used as a prompt to press the CTA button. For example, in the case of a weather report announcing severe weather, it is possible to determine who has taken note of the corresponding message and who has not.

In another further embodiment of the method described, a program is executed when the operator feedback is received. In this way, it is possible to react to the actuating of the CTA button with suitable measures and interact with the user. In the case of the aforementioned weather report and the announcement of severe weather, initial emergency measures can be initiated in this way, such as the offer to keep the user constantly informed about the current weather situation by means of a rain radar program.

In a particular further embodiment of the specified method, the program is executed as a function of data identifying the user. In this way, the aforementioned interaction with the user can be tailored to the user. In the case of the aforementioned weather report and the announcement of severe weather, the first emergency measures can be started in accordance with the user, for example to contact the user directly via a telephone program if it is known from his identifying data that he needs help in the event of a disaster.

In another particular further embodiment of the specified method, a message is generated based on the user feedback and reported back to a server, which makes it possible to coordinate interaction with the users. It is also possible, for example, to use A/B tests to check whether and how the system works for certain user groups as part of push messages sent as a test. Although current methods can already be used to determine whether and how such push messages are generally perceived in a group, this is only possible, however, with estimates based on models and observations. However, the great advantage of the method described lies in the direct measurement, the result of which is available immediately. By confirming the CTA button, it can be ensured that desirable reactions or even necessary measures that may have to be taken (e.g. in the case of severe weather warnings) can actually be implemented as quickly as possible. The time between information and reaction by whomever can thus be significantly shortened.

In a preferred further embodiment of the specified method, the operating feedback comprises information on a multimedia content that is displayed on the screen immediately before the CTA button is displayed. In this way, conclusions can be drawn about the user's level of knowledge they had when they operated the CTA button. For example, if the above-mentioned push message is sent to all users of a television program, regardless of whether they are watching the weather report with the severe weather warning or not, it can be estimated whether they are aware of the impending danger.

In a particularly preferred embodiment of the specified method, the server has previously sent the push message that is based on the event. In this way, feedback can be realized, especially in the above-mentioned tests, which makes it possible to automatically optimize the system.

According to a further aspect of the invention, a control device is arranged to perform one of the specified methods.

In a further embodiment of the specified device, the specified device comprises a memory and a processor. The specified method is stored in the memory in the form of a computer program, and the processor is provided for executing the method when the computer program is loaded from the memory into the processor.

According to a further aspect of the invention, a computer program comprises program code means for performing all steps of the specified method when the computer program is executed on an electronic device or one of the specified devices.

According to a further aspect of the invention, a computer program product comprises a program code stored on a computer readable data carrier which, when executed on a data processing device, performs the specified method.

According to a further aspect of the invention, a system comprises one of said control devices, said remote control having said CTA button, and said signal transmitter, which is preferably said display screen.

In a particular embodiment of the system, the control device is a set-top box.

Compared to other communication channels, this form of direct communication with the user is more cost-effective because it is implemented via an already existing infrastructure.

In a preferred embodiment of the system, the control device is set up to receive the push message that is based on the event with the configuration information via the Internet, to send the push command to the signal transmitter via a High-Definition Multimedia Interface connection called HDMI connection, and to send the configuration instruction to the remote control via a Bluetooth Low Energy connection called BLE connection.

### BRIEF DESCRIPTION OF FIGURES

The features, characteristics and advantages of the present invention described above and the manner in which they are achieved will become more understandable in connection with the following description of the embodiments, which will be explained in more detail in connection with the drawing, including:

FIG. 1 showing a schematic representation of a system consisting of a television set and a remote control,

FIG. 2 showing a schematic representation of a network with the system of FIG. 1, and

FIG. 3 showing a sequence diagram of a process in the network of FIG. 2.

In the figures, identical technical elements are given the same reference signs and are only described once. The figures are purely schematic and, in particular, do not reflect the actual geometric proportions.

### DETAILED DESCRIPTION

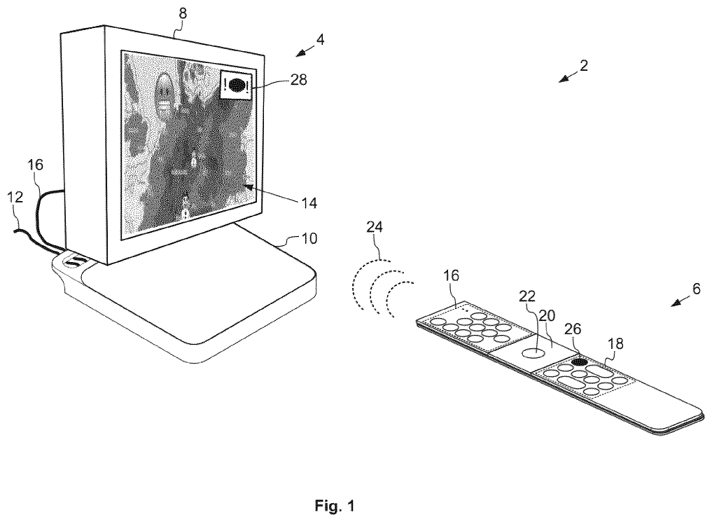

Reference is made to FIG. 1, which shows a schematic representation of a system 2 comprising a television set 4 and a remote control 6.

The television set 4 comprises a screen 8 to which a set-top box 10 is connected. The set-top box 10 receives a data stream containing a video 14 via a network connection 12, which is shown as a network cable in FIG. 1 as an example. The set-top box 10 filters the video 14 from the data stream and outputs a video signal carrying the video 14 to the screen 8 via a screen cable 16 in order to display the video 14 on the screen 8.

Before the video 14 is discussed in more detail, the control of the television set 4 using the remote control 6 will be discussed first.

The remote control 4 comprises a first keypad 16 and a second keypad 18, which are separated from each other by a directional pad 20. A confirmation button 22 is located in the center of the directional pad 20. This structure is basically known and does not need to be explained further. The buttons of the keypads 16, 18 as well as the directional pad 20 and the confirmation button 22 are used to enter control commands in order to control the function of the television set 4. For this purpose, the inputs are sent in a transmission signal 24 to the set-top box 10, which filters the inputs from the transmission signal 24 and then performs functions on the television set 4 corresponding to the inputs, such as volume control, program selection and the like.

A special button on the remote control, which is hatched in FIG. 1 and provided with the reference sign 26, is used for a special function on the television set 4. The idea is to execute this as a call-to-action button, hereinafter referred to as CTA button 26, and to motivate or guide the viewer and thus user of the remote control 6 to a specific action. In the present embodiment, the specific action is exemplary in connection with the video 14, which is executed as a weather report announcing severe weather in the form of a cold wave. The purpose of the specific action is for the viewer to actively confirm that they have taken note of the severe weather reported in the weather report. To this end, the viewer is prompted with a corresponding image 28 of the CTA button 26, which is superimposed on the video 14.

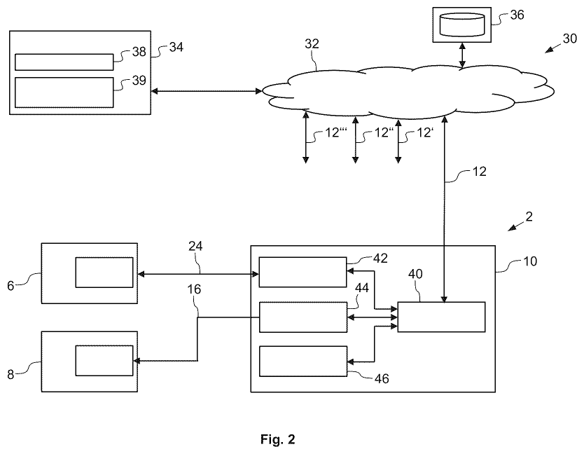

To explain an implementation of this idea, reference is made to FIG. 2, which shows a network 30 in which the system 2 from FIG. 1 is integrated alongside other similar systems not shown. These other integrated systems are indicated in FIG. 2 by further network connections 12′, 12″ and 12′″.

The system 2 and the other systems are connected to each other in the network 30 via bidirectional network connections as network connections 12, which can be realized, for example, via the Internet 32. The network connections should be as fail-safe as possible, which can be achieved for example through redundancy and/or by a satellite network connection, as provided by the company Starlink. In addition, a programming system 34 and a control system 36 are integrated into the network 30, which together implement the above-mentioned idea behind the CTA button 26. In contrast to this, the system 2 described above is hereinafter referred to as subscriber system 2.

The programming system 34 is used below to define and manage so-called campaigns. A campaign is hereinafter to be understood as an organized action or series of actions to motivate the viewers of the video 14 or other videos on the screen 8 to press the CTA button 26, with the aim of confirming their awareness of the severe weather. However, a campaign within the meaning of the disclosure may also have other objectives, such as promoting a product or service, an idea, or a political agenda. To define or control a campaign, a content management system (CMS) is implemented in the control system 34, which an operator can use to carry out the necessary programming steps. Programming is a known skill and depends on the programming language selected. Therefore, we will not go into further detail here.

The most efficient way to implement the system is with a subscriber system in which interested participants register. The main advantage of this is that it also avoids data protection problems that arise when participants' data is collected in a way that is necessary for the implementation of the aforementioned idea. A further advantage of the subscriber system is that subscribers can be specifically addressed if the severe weather message in the video 14 concerns them. For this purpose, a subscriber management system 39 is available in the control system 34, with which the subscribers can be entered, managed and, if necessary, deleted. To uniquely identify a subscriber, the identification of the set-top box 10, the identification of the remote control 6 and the identification of the household that owns the system 2 can be stored in the subscriber management system 39, for example.

A campaign is controlled by the control system 36. Here, the campaigns programmed by the programming system 34 are managed and, if necessary, provided with predefined parameters when a campaign is started. In the case of the above-mentioned severe weather warning, for example, this can be the addition of data such as expected temperature and time to previously stored information texts. Furthermore, when a campaign is started, the group of subscribers to be addressed by the campaign is determined, for example, on the basis of the identification of the set-top box 10. Such a group of subscribers is referred to below as a cohort. The control system 36 is also responsible for sending the campaign data, such as the identification of the campaign, media data, texts, etc., to the individual set-top boxes 10. In order to evaluate a campaign, the control system 36 can also receive evaluation data from the individual participants of the cohort, which in particular contains feedback on which remote control 6 the CTA button 26 was pressed. Finally, the control system 36 can also be used to perform evaluations, such as the well-known A/B testing.

The control system 36 communicates via the network connection 12 with a campaign management service 40 in the set-top box 10 of the respective subscriber system 2 in order to control the campaign started there. The campaign management service 40 can in principle be designed as a physical stand-alone unit, for example to retrofit older set-top boxes with the functionality according to the idea described. Alternatively, the campaign management service 40 can also be implemented in the set-top box 10 as a program, which is preferred for cost reasons. In order to manage a campaign on the participant side, the campaign management service 40 stores the above-mentioned campaign data and holds important information about the household targeted by the campaign. In the case of the above-mentioned severe weather warning, such information may be, for example, the age of the household members or the like in order to estimate, based on the reaction of the subscriber or viewer, how urgent any emergency measures required might be in the event that the CTA button 26 is not pressed.

The campaign management service 40 also communicates with other components of the set-top box 10 to control the campaign. In the present case, this includes a communication interface to the remote control 6, referred to as BLE interface 42, a communication interface to the screen 8, referred to as HDMI interface 44, and the actual operating system of the set-top box 10, which is typically, but not necessarily, an Android operating system 46.

The campaign management service 40 sends the request to the viewer or subscriber to press the CTA button 26 in the transmission signal 24 via the BLE interface 42. The CTA button 26 may preferably have a variable design, and the campaign management service 40 may also send an image of how the CTA button 26 should be designed specifically for the campaign in addition to the request. The campaign management service 40 then waits for a response from the remote control 6 as to whether the CTA button 26 on the remote control 6 has actually been pressed. Upon receiving a response, the campaign management service 40 may capture a time stamp documenting the actuation of the CTA button 26, which is hereinafter referred to as a remote control unit event (RCU event). Alternatively or additionally, the campaign management service 40 may also capture a time stamp documenting where the video is located. In contrast to the RCU event, this event is referred to as DMB event (Digital Multimedia Broadcasting event). The BLE interface 42 can basically use any suitable transmission protocol, but must be designed in such a way that bidirectional communication is possible.

Bidirectional communication is not absolutely necessary for the HDMI interface 44. The campaign management service 40 merely sends data to the screen 8 via the HDMI interface 44 without waiting for a response. When starting a campaign, the data sent via the HDMI interface 44 comprises the request to press the CTA button 26, which is displayed on the screen 8 in the form of the FIG. 28 of the CTA button 26 and is superimposed on the video 14. The campaign management service 40 may also send campaign background information and other data to the screen 8 via the HDMI interface 44, if required. Finally, the campaign management service 40 hides all of this data at an appropriate time, for example after the CTA button 26 is pressed or after a campaign is completed.

Finally, the campaign management service 40 may also alter the Android operating system 46, for example, in order to automatically playback videos, start programs or install or establish communication channels, for example to establish a telephone connection. The selection depends on the application purpose. In the case of the above-mentioned severe weather warning, for example a video communication connection could be established when the subscriber has reached a certain age and might possibly need help to coordinate the required help by telephone.

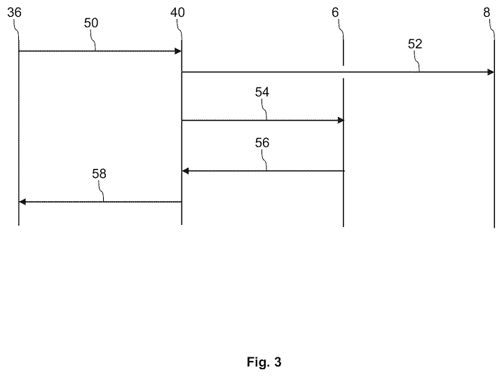

To illustrate the flow of news during a campaign, reference is made to the sequence diagram in FIG. 3.

First, the control system 36 sends a push message 50 to the campaign management service 40 in the set-top box 10 of the respective subscriber system 2. This message contains all necessary information to present a campaign to the viewer or subscriber and ask them to activate the CTA button 26. In response to this push message 50 the campaign management service 40 generates a push command 52 and a configuration instruction 54. In addition to optional background information on the campaign, such as the severe weather warning, the push command 52 contains the request to activate the CTA button 26, as well as the display 28 of the CTA button 26, which is to be superimposed on the video 14, and is sent to the screen 8. In parallel to this, the configuration instruction 54 also contains the display 28 of the CTA button 26, together with the instructions about the display on the remote control, if necessary. The configuration instruction may deviate from the display and, for example, only illuminate the CTA button 26 or similar.

The campaign management service 40 then waits for feedback 56 of the remote control 6 as to whether the CTA button 26 has actually been activated, and sends a confirmation message 58 to the control system 36 to confirm that the CTA button has been pressed.

1. A method for notifying a user of an event comprising:
receiving a push message that is based on the event including configuration information describing configuration of a call-to-action (CTA) button on a remote control, at least in part;
generating a push command instructing a signal transmitter to prompt the user to press the CTA button on the remote control;
generating a configuration instruction that instructs the remote control to configure the remote control in an area of the CTA button based on the configuration information;
sending the push command to the signal transmitter;
sending the configuration instruction to the remote control; and
sending a message indicating operation of the CTA button by the user to a control system.

2. The method of claim 1, wherein the push command comprises the configuration information, and a screen as a signal transmitter is instructed to display an image of the CTA button.

3. The method of claim 2, wherein the image of the CTA button is superimposed over another image on the screen.

4. The method of claim 1, further comprising executing a program upon reception of operating feedback.

5. The method of claim 4, wherein the program is executed as a function of data identifying the user.

6. The method of claim 1, further comprising sending a message generated based on user feedback to a server.

7. The method of claim 1, wherein the operating feedback contains information on a multimedia content that is displayed on a screen immediately before the CTA button is displayed, wherein a server has sent the push message that is based on the event.

8. A control device comprising a non-transitory computer readable medium having instructions recorded thereon, the instructions when executed by a computer implementing the method of claim 1.

9. A remote control configured to communicate with the control device of claim 8, comprising:
a call-to-action button;
a communication device configured to receive configuration information; and
an actuator configured to customize the remote control in an area of the call-to-action button based on the configuration information.

10. A system comprising:
the control device of claim 8;
a remote control configured to communicate with the control device, wherein the remote control comprises: a call-to-action button, a communication device configured to receive configuration information, and an actuator configured to customize the remote control in an area of the call-to-action button based on the configuration information; and
the signal transmitter.
